(19) United States
(12) Patent Application Publication
(10) Pub. No.: US 2020/0338735 A1
(43) Pub. Date: Oct. 29, 2020

(54) Sensorless Collision Detection Method Of Robotic Arm Based On Motor Current

(71) Applicant: Xi'an Jiaotong University, Xi'an (CN)

(72) Inventors: Longlei Dong, Xi'an (CN); Linjie MA, Xi'an (CN); Jian YAN, Xi'an (CN); Yi HAN, Xi'an (CN); Wei GUAN, Xi'an (CN)

(21) Appl. No.: 16/853,358

(22) Filed: Apr. 20, 2020

(30) Foreign Application Priority Data
Apr. 28, 2019 (CN) 201910349412.9

(51) Int. Cl. B25J 9/16

(52) U.S. Cl. CPC B25J 9/1676; B25J 9/1653; B25J 9/1658; B25J 9/161

(57) ABSTRACT

A sensorless collision detection method of robotic arm based on motor current includes acquiring an output current of a robotic arm joint motor; building a neural network, and using a backpropagation algorithm to update the weights and the deviations of the neural network to obtain an estimated current value; judging whether collision occurs by comparing the collision detection threshold with the error value between the output current of the robotic arm joint motor and the estimated output current of the neural network. The detection method is easy to operate and has higher universality.

### CROSS-REFERENCE TO RELATED APPLICATIONS

This application claims the benefit and priority of Chinese Application No. 201910349412.9, filed Apr. 28, 2019. The entire disclosure of the above application is incorporated herein by reference.

### FIELD

The present disclosure relates to the field of robotic arm collision detection technologies, and specifically to a sensorless collision detection method of robotic arm based on motor current.

### BACKGROUND

Recently, a robotic arm is widely applied to the fields of aerospace, industrial production, medical treatment, home and the like. However, when a robot works, it is very likely to collide with a person or an object suddenly appearing in its working space. If the robot cannot accurately identify the collision and conduct timely response, it is very likely to cause an enormous threat to the safety of the person or the object. So, the safety of the robot is a problem to be considered firstly during working.

Currently, multiple methods are proposed for the robot collision detection. A general collision detection method is to mount various sensors on a robotic arm, such as a wrist sensor, a visual sensor, perceptive skin and the like. Although the mounted sensor can quickly detect the collision, it also increases the production costs of the robot and the complexity of a robotic system. In view of this, some scholars further propose a sensorless collision detection method. For example, there is a method comprising the following steps: comparing a torque output of a robotic arm joint motor with an estimated torque output of a mathematic model, calculating the error between these two torque outputs, and setting a threshold for a detection system; if the error is greater than the threshold, determining that the robot has collision. However, calculation of the error generally needs an accurate robot dynamic model and an acceleration magnitude. The actual acceleration generally contains noise and is hard to be estimated. The dynamic model of the robot changes along with time. For a robot with the low degree of freedom, such as one or two degrees of freedom, its dynamic model is relatively simple to the error calculation; but for a robot with the high degree of freedom, its dynamic model is very complex to largely increase the calculation complexity, so the dynamic model is unusable at this time.

### SUMMARY

Aiming at the defects in the prior art, a technical problem to be solved by the present disclosure is to propose a sensorless collision detection method of robotic arm based on motor current to achieve sensorless collision detection by utilizing the current error of a robotic arm joint motor.

The present disclosure adopts the following technical solution: A sensorless collision detection method of robotic arm based on motor current comprises: acquiring an output current of a robotic arm joint motor; building a neural network, and using a backpropagation algorithm to update weights and deviations of the neural network to obtain an estimated current value; and judging whether a collision occurs by comparing a collision detection threshold with an error value between the output current of the robotic arm joint motor and the estimated current value of the neural network.

Specifically, the output current of the robotic arm joint motor is filtered by utilizing a Butterworth filter.

Further, the normalized transfer function H(s) of the Butterworth filter is:

$$H ( s ) = {\prod }_{k - 1}^{n / 2} \frac{1}{{s}^{2} - 2 s sin ( \frac{2 k - 1}{2 n} π ) + 1}$$

Where, s=jω; ω is signal frequency; k=1, 2, . . . , n/2; n=2, 4, 6, . . . , which is the filter order.

Specifically, the neural network comprises the input layer, the hidden layer and the output layer. The input layer inputs position, velocity and current information of a previous time of each joint motor; then based on calculation, the output layer outputs an estimated current value of each joint motor.

Further, the estimated current value î_{NN,p} of the p^{th} joint to be estimated by the neural network is:

$${\hat{ι}}_{N N , p} = [ {\sum }_{i = 1}^{{n}_{h}} {ω}_{k i}^{3} ( \frac{1}{1 + exp ( - ( {Σ}_{j = 1}^{{n}_{i}} {ω}_{i j}^{2} {x}_{i} + {b}_{j}^{2} ) )} ) ] + {b}_{i}^{3}$$

Where, p=1, 2, . . . , n, which is the number of robotic arm joint motors; ωᵢⱼ² is a connection weight from the j^{th} neuron of the first layer to the i^{th} neuron of the second layer; ωₖᵢ³ is a connection weight from the i^{th} neuron of the second layer to the k^{th} neuron of the third layer; bⱼ² is a deviation of the j^{th} neuron from the first layer to the second layer; bᵢ³ is a deviation of the i^{th} neuron from the second layer to the third layer; xᵢ is the i^{th} input value of an input vector X; nᵢ is the number of neurons on the input layer; nₕ is the number of neurons on the hidden layer.

Specifically, if the error is larger than the detection threshold, it is determined that the robot is collided, and the robotic arm is converted from an original control program to relative collision response control; if the error is smaller than the detection threshold, the robotic arm operates according to the original control program, meanwhile, the neural network utilizes the backpropagation algorithm to update the weights and the deviations of the neural network.

Further, in the step of utilizing the backpropagation algorithm to update the weights and the deviations of the neural network in real time, each parameter expression is as follows:

$$Δ {ω}_{i j}^{2} ( t ) = η {s}_{i}^{2} ( 1 - {s}_{i}^{2} ) {x}_{i} [ {\sum }_{k = 1}^{{n}_{o}} {υ}_{k} {ω}_{k i}^{3} ] + α Δ {ω}_{i j}^{2} ( t - 1 )$$

$$Δ {ω}_{k i}^{3} ( t ) = {ηυ}_{k} {s}_{i}^{2} + α Δ {ω}_{k i}^{3} ( t - 1 )$$

$$Δ {b}_{j}^{2} ( t ) = η {s}_{i}^{2} ( 1 - {s}_{i}^{2} ) [ {\sum }_{k = 1}^{{n}_{o}} {υ}_{k} {ω}_{k i}^{3} ] + α Δ {b}_{j}^{2} ( t - 1 )$$

$$Δ {b}_{k}^{3} ( t ) = η {υ}_{k} + α Δ {b}_{k}^{3} ( t - 1 )$$

$${s}_{i}^{2} = \frac{1}{1 + exp ( - ( {\sum }_{j = 1}^{{n}_{i}} {ω}_{i j}^{2} {x}_{i} + {b}_{j}^{2} ) )}$$

Where, sᵢ² is the activation function of the i^{th} neuron of the second layer; ωᵢⱼ² is the connection weight from the j^{th} neuron of the first layer to the i^{th} neuron of the second layer; ωₖᵢ³ is the connection weight from the i^{th} neuron of the second layer to the k^{th} neuron of the third layer; bⱼ² is the deviation of the j^{th} neuron from the first layer to the second layer; Δbₖ³(t) is the deviation of the k^{th} neuron from the second layer to the third layer; nₒ is the number of neurons on the output layer; η and α are respectively the learning rate of the neural network and the momentum coefficient.

Compared with the prior art, the present disclosure at least has the following beneficial effects:

The present disclosure provides a collision detection method of the robotic arm based on the neural network. The neural network is built to obtain the estimated current value of a motor; the output current of the motor is acquired according to the Hall effect; after the acquired output current of the motor is filtered by utilizing the Butterworth filter, the error between the output current of the motor and the estimated current is calculated; the error is compared with the collision detection threshold to judge whether the robotic arm is collided with an outside object. In the present disclosure, it is unnecessary to build a complex system dynamic model and measure the acceleration; the calculation is highly efficient; the present disclosure can be easily applied to the existing system without the need of changing the structure of the robotic arm. In the actual application, only the motor current needs to be detected. The method for conducting the collision detection by directly utilizing the current data of the robotic arm joint motor avoids mounting extra sensors on the robotic arm so as to reduce the production costs of the robotic arm.

Further, the Butterworth filter is configured to filter the current data such that the preset collision detection threshold is more accurate.

Further, a three-layer neural network model is built to estimate the current to avoid building a complex dynamic model of the robotic arm and also to help the collision detection method proposed by the present disclosure to have better universality.

Further, the error between the actual current and the estimated current is calculated to be compared with the preset threshold so as to judge whether collision occurs; if the collision occurs, the robotic arm is immediately actuated to make a response; if the collision does not occur, the algorithm of the neural network is updated.

Further, the weights and the deviations of the neural network are updated in real time by utilizing the backpropagation algorithm such that the estimated current value outputted by the neural network is closer to the actual current value outputted by the robotic arm during normal operation. Therefore, when the robotic arm is collided, the error between its actual current and the estimated current is increased to be larger than the preset threshold to improve the accuracy of the collision detection.

In conclusion, the present disclosure calculates based on the neural network, does not need to build the complex system dynamic model, and also does not need to measure the acceleration. Therefore, the calculation is highly efficient, and the present disclosure can be easily applied to the existing system and does not need to change the structure of the robotic arm. In the actual application, only the motor current needs to be detected. The method for conducting the collision detection by directly utilizing the current data of the robotic arm joint motor avoids mounting extra sensors on the robotic arm so as to reduce the production costs of the robotic arm.

The following further describes the technical solution of the present disclosure in detail with reference to the accompanying drawings and embodiments.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic structural diagram of a total technical solution of the present disclosure.

FIG. 2 is a flow chart of a collision detection method based on a neural network.

FIG. 3 is a schematic structural diagram of a neural network.

In the drawings, 1-input layer, 2-hidden layer, 3-output layer, 4-neuron, 5-network.

### DETAILED DESCRIPTION

The present disclosure provides a sensorless collision detection method of robotic arm based on motor current, which calculates the error between an output current of a robotic arm joint motor and an estimated output current of a neural network and compares the error with a preset threshold in a collision detection module to judge whether collision occurs.

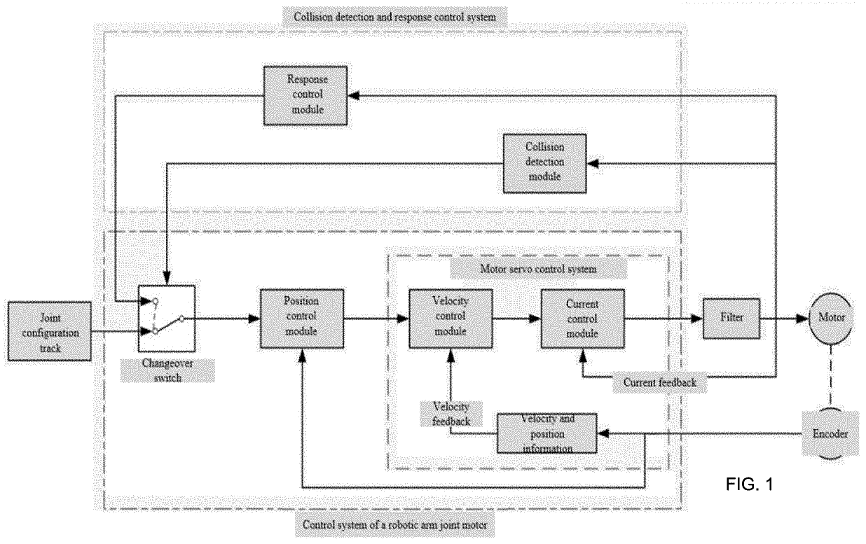

Referring to FIG. 1, a sensorless collision detection system of a robotic arm based on a motor current comprises a control system of a robotic arm joint motor, a filter, a collision detection and response control system, a motor and an encoder. The control system of the robotic arm joint motor comprises a changeover switch, a position control module and a motor servo control system. The motor servo control system comprises a velocity control module and a current control module. The collision detection and response control system comprises a response control module and a collision detection module.

One end of a selection end of the changeover switch is connected with a joint configuration track while the other end is connected with the response control module and the collision detection module. A public end of the changeover switch is connected with the motor sequentially through the position control module, the velocity module, the current control module and the filter. The encoder is connected with the motor and is used for transmitting velocity and position information to the velocity control module through velocity feedback. The response control module and the collision detection module transmit current feedback to the current control module.

The present disclosure provides a sensorless collision detection method of robotic arm based on motor current, comprising the following steps:

S1: Calculating the current error. According to the technical solution of the present disclosure, the collision is judged by comparing the current error with the preset threshold so that a difference between the output current of the motor and the estimated current of the neural network should be calculated.

The current error is deduced by the following formula, and formula (1) is the dynamic model description of n-DOF robotic arm, and formula (2) is the linear relationship between motor torque and current.

M(q)\ddot{q}+C(q,\dot{q})\dot{q}+g(q)=τ (1)

Where, q, \dot{q}, \ddot{q}∈ [symbol] ⁿ respectively are position, velocity and acceleration vectors of the robotic arm joint; M(q)∈ [symbol] ^{n×n} is a positive definite and symmetric inertia matrix of the robotic arm, C(q, \dot{q})∈ [symbol] ^{n×n} is a Coriolis matrix, g(q)∈ [symbol] ⁿ is a gravity vector of the robotic arm, and τ∈ [symbol] ⁿ is a motor torque.

τ=T_{c}i (2)

Where, T_{c} is a constant of the motor torque and can be directly obtained from a motor manual, i∈ [symbol] ⁿ is an output current vector of each motor.

Supposing

$$\frac{1}{{T}_{c}} = c ,$$

an integrator is introduced to express the estimated current as follows:

î(t+1)=K∫(i(t)−î(t))dt (3)

Where, î∈ [symbol] ⁿ is an estimated current vector; K is a gain.

Formula (1) and formula (2) are substituted into formula (3) to obtain the following formula (4):

î(t+1)=K∫(c(M(t)\ddot{q}(t)+C(t)\dot{q}(t)+g(t))−î(t))dt (4)

Considering that the acceleration generally contains noise components, formula (5) and formula (6) are introduced to eliminate influence of the acceleration \ddot{q} in the above formula:

$$\frac{d}{dt} M ( q ) \dot{q} = M ( q ) \ddot{q} + \dot{M} ( q ) \dot{q} \qquad ( 5 )$$

Because M(q) is a positive definite matrix and C(q, \dot{q}) is a skew symmetric matrix, \dot{M}(q)−2C(q, \dot{q}) is a skew symmetric matrix and is called N(q, \dot{q}). According to its property N(q, \dot{q})=−N^{T}(q, \dot{q}), the following formula is obtained:

\dot{M}(q)=C^{T}(q,\dot{q})+C(q,\dot{q}) (6)

So, formula (4) is rewritten as follows:

î(t+1)=K{∫(c(ĝ(t)−Ĉ^{T}(t)\dot{q}(t)−î(t)dt+C\hat{M}(t)\dot{q}(t)} (7)

The error of the current of the joint motor is obtained as follows:

r=i−î (8)

S2: Configuring a filter. Because of existence of friction and disturbance during motor operation, the current generally contains the noise. Therefore, the present disclosure designs a Butterworth filter to filter the current data such that the set collision detection threshold is more accurate.

The transfer function of the Butterworth filter is:

$$H ( s ) = {\prod }_{k - 1}^{n / 2} \frac{1}{{s}^{2} - 2 s sin ( \frac{2 k - 1}{2 n} π ) + 1} \qquad ( 9 )$$

S3: Building a neural network. A three-layer neural network model is built to estimate the current to avoid building a complex dynamic model of the robotic arm and also to help the collision detection method proposed by the present disclosure to have better universality. Meanwhile, a backpropagation algorithm is used to update the weights and the deviations of the neural network.

The following sigmoid function is selected as an activation function of the neural network:

$$f ( x ) = \frac{1}{1 + {e}^{- x}}$$

By simulating formula (7), a current estimated by the neural network is obtained as follows:

$${\hat{ι}}_{N N , p} = [ {Σ}_{i = 1}^{{n}_{h}} {ω}_{k i}^{3} ( \frac{1}{1 + exp ( - ( {Σ}_{j = 1}^{{n}_{t}} {ω}_{t j}^{2} {x}_{t} + {b}_{{j}^{2}} ) )} ) ] + {b}_{i}^{3} \qquad ( 10 )$$

Where, p=1, 2, . . . , n, which is the number of robotic arm joint motors; î_{NN,p} is an estimated current of the p^{th} joint motor; ωᵢⱼ² is a connection weight from the j^{th} neuron of the first layer to the i^{th} neuron of the second layer; ωₖᵢ³ is a connection weight from the i^{th} neuron of the second layer to the k^{th} neuron of the third layer; bⱼ² is a deviation of the j^{th} neuron from the first layer to the second layer; bᵢ³ is a deviation of the i^{th} neuron from the second layer to the third layer; xᵢ is the i^{th} input value of an input vector X; nᵢ is the number of neurons on the input layer; nₕ is the number of neurons on the hidden layer.

Now, formula (8) can be represented as follows:

r=i−î_{NN} (11)

The backpropagation algorithm is utilized to update the weight and the deviation of the neural network in real time. Each parameter expression in formula (10) is as follows:

$$\begin{matrix}Δ {ω}_{i j}^{2} ( t ) = η {s}_{i}^{2} ( 1 - {s}_{i}^{2} ) {x}_{i} [ {\sum }_{k = 1}^{{n}_{o}} {υ}_{k} {ω}_{k i}^{3} ] + α Δ {ω}_{i j}^{2} ( t - 1 ) & ( 12 ) \\ Δ {ω}_{k i}^{3} ( t ) = η {υ}_{k} {s}_{i}^{2} + α Δ {ω}_{k i}^{3} ( t - 1 ) & ( 13 ) \\ Δ {b}_{j}^{2} ( t ) = η {s}_{i}^{2} ( 1 - {s}_{i}^{2} ) [ {\sum }_{k = 1}^{{n}_{o}} {υ}_{k} {ω}_{k i}^{3} ] + α Δ {b}_{j}^{2} ( t - 1 ) & ( 14 ) \\ Δ {b}_{k}^{3} ( t ) = η {υ}_{k} + α Δ {b}_{k}^{3} ( t - 1 ) & ( 15 ) \\ {s}_{i}^{2} = \frac{1}{1 + e x p ( - ( {Σ}_{j = 1}^{{n}_{i}} {ω}_{ij}^{2} {x}_{i} + {b}_{{j}^{2}} ) )} & ( 16 )\end{matrix}$$

Where, vₖ=i(t−1)−î_{NN,p}(t), which is a training signal of the neural network for training an output signal î_{NN,p} to meet vₖ=0; sᵢ² is an activation function of the i^{th} neuron of the second layer; nₒ is the number of neurons on the output layer; η and α are respectively the learning rate of the neural network and the momentum coefficient.

S4: Setting the collision detection threshold. A relative threshold is set to conduct collision judgement by analyzing a training result of the neural network.

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. Apparently, the described embodiments are some but not all of the embodiments of the present disclosure. Generally, components of embodiments of the present disclosure described and shown in the accompanying drawings may be arranged and designed in various manners. Therefore, the following detailed description of the embodiments of the present disclosure in the accompanying drawings is not intended to limit the protection scope of the present disclosure, but merely represent selected embodiments of the present disclosure. All other embodiments obtained by a person of ordinary skill in the art based on the embodiments of the present disclosure without creative efforts shall fall within the protection scope of the present disclosure.

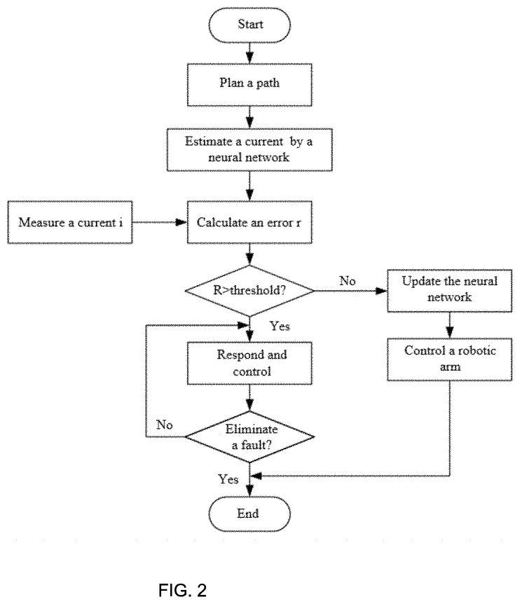

(1) Referring to FIG. 2, the collision detection method of the present disclosure should comprise a robot, and the robot should comprise a planned state. In an embodiment, the robot may be a spot-welding industrial robot and the like.

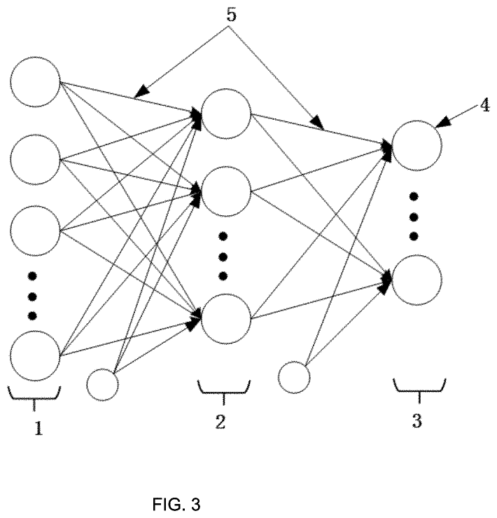

(2) Referring to FIG. 3, the neural network of the present disclosure totally has three layers, including the input layer 1, the hidden layer 2 and the output layer 3. A plurality of neurons 4 are arranged on the input layer 1, the hidden layer 2 and the output layer 3. Weights and deviations among the input layer 1, the hidden layer 2 and the output layer 3 are transmitted through a network 5. Position, velocity and current information at a previous time of each joint motor is inputted on the input layer, and then the estimated current value of the neural network is obtained according to formula (10).

(3) The current of the robotic arm joint motor generally cannot be directly measured, but can be measured by utilizing a Hall effect sensor. Meanwhile, the Butterworth filter is utilized to filter the current data.

(4) The current error is calculated through formula (11).

(5) In an embodiment, the current error is compared with the preset collision detection threshold; if the current error is larger than the collision detection threshold, the robot is determined to be collided, and the robotic arm is converted from an original control program to a relative collision response control; if the current error is smaller than the collision detection threshold, the robotic arm operates according to the original control program; meanwhile, the neural network also utilizes the backpropagation algorithm to continuously update the weight and the deviation of the neural network according to formulas (12) to (16).

(6) In the embodiment, after the fault of robotic arm is eliminated, the robotic arm returns to operate the control program till the operation is completed.

The above-mentioned contents are merely the technical idea of the present disclosure, but are not used to limit the protection scope of the present disclosure. Any changes made on the basis of the technical solution according to the technical idea of the present disclosure shall fall within the protection scope of the appended claims of the present disclosure.

What is claimed is:

1. A sensorless collision detection method of robotic arm based on motor current, comprising:
acquiring an output current of a robotic arm joint motor;
building a neural network, and using a backpropagation algorithm to update weights and deviations of the neural network to obtain an estimated current value; and
judging whether a collision occurs by comparing a collision detection threshold with an error value between the output current of the robotic arm joint motor and the estimated current value of the neural network.

2. The sensorless collision detection method of robotic arm based on motor current according to claim 1, further comprising filtering the output current of the robotic arm joint motor by utilizing a Butterworth filter.

3. The sensorless collision detection method of robotic arm based on motor current according to claim 2, wherein filtering the output current comprises filtering the output current using a normalized transfer function H(s) of the Butterworth filters:
$$H ( s ) = {\prod }_{k - 1}^{n / 2} \frac{1}{{s}^{2} - 2 s sin ( \frac{2 k - 1}{2 n} π ) + 1}$$
wherein s=jω; ω is signal frequency; k=1, 2, . . . , n/2; n=2, 4, 6, . . . , which is a filter order.

4. The sensorless collision detection method of robotic arm based on motor current according to claim 1, wherein building the neural network comprises building the neural network comprising an input layer, a hidden layer and an output layer; the input layer inputting position, velocity and current information of a previous time of each joint motor; then based on calculation, outputting at the output layer an estimated current value of each joint motor.

5. The sensorless collision detection method of robotic arm based on motor current according to claim 4, wherein outputting the estimated current value comprises outputting the estimated current value î_{NN,p} of a p^{th} joint by estimating the neural network using:
$${\hat{ι}}_{N N , p} = [ {\sum }_{i = 1}^{{n}_{h}} {ω}_{k i}^{3} ( \frac{1}{1 + exp ( - ( {Σ}_{j = 1}^{{n}_{i}} {ω}_{i j}^{2} {x}_{i} + {b}_{j}^{2} ) )} ) ] + {b}_{i}^{3}$$
wherein p=1, 2, . . . , n, which is a number of robotic arm joint motors; ωᵢⱼ ² is a first connection weight from a j^{th} neuron of a first layer to a i^{th} neuron of a second layer; ωₖᵢ³ is a second connection weight from the i^{th} neuron of the second layer to a k^{th} neuron of a third layer; bⱼ² is a deviation of the j^{th} neuron from the first layer to the second layer; bᵢ³ is a deviation of the i^{th} neuron from the second layer to the third layer; xᵢ is an i^{th} input value of an input vector X; nᵢ is a number of neurons on an input layer; nₕ is a number of neurons on a hidden layer.

6. The sensorless collision detection method of robotic arm based on motor current according to claim 1, wherein if the error value is larger than the collision detection threshold, determining the robot has collided, and the robotic arm is converted from an original control program to relative collision response control; if the error value is smaller than the collision detection threshold, the robotic arm operates according to the original control program, meanwhile, utilizing the neural network the backpropagation algorithm to update the weights and the deviations of the neural network.

7. The sensorless collision detection method of robotic arm based on motor current according to claim 5, wherein in the step of utilizing the backpropagation algorithm to update the weights and the deviations of the neural network in real time comprises utilizing the backpropagation algorithm wherein each parameter expression is:
$$\begin{matrix}Δ {ω}_{i j}^{2} ( t ) = η {s}_{i}^{2} ( 1 - {s}_{i}^{2} ) {x}_{i} [ {\sum }_{k = 1}^{{n}_{o}} {υ}_{k} {ω}_{k i}^{3} ] + α Δ {ω}_{i j}^{2} ( t - 1 ) \\ Δ {ω}_{k i}^{3} ( t ) = η {υ}_{k} {s}_{i}^{2} + α Δ {ω}_{k i}^{3} ( t - 1 ) \\ Δ {b}_{j}^{2} ( t ) = η {s}_{i}^{2} ( 1 - {s}_{i}^{2} ) [ {\sum }_{k = 1}^{{n}_{o}} {υ}_{k} {ω}_{k i}^{3} ] + α Δ {b}_{j}^{2} ( t - 1 ) \\ Δ {b}_{k}^{3} ( t ) = η {υ}_{k} + α Δ {b}_{k}^{3} ( t - 1 ) \\ {s}_{i}^{2} = \frac{1}{1 + exp ( - ( {Σ}_{j = 1}^{{n}_{i}} {ω}_{ij}^{2} {x}_{i} + {b}_{{j}^{2}} ) )}\end{matrix}$$
wherein sᵢ² is an activation function of the i^{th} neuron of the second layer; ωᵢⱼ² is the first connection weight from the j^{th} neuron of the first layer to the i^{th} neuron of the second layer; ωₖᵢ³ is the second connection weight from the i^{th} neuron of the second layer to the k^{th} neuron of the third layer; bⱼ² is the deviation of the j^{th} neuron from the first layer to the second layer; Δbₖ³(t) is a deviation of the k^{th} neuron from the second layer to the third layer; nₒ is a number of neurons on the output layer; η and α are respectively a learning rate of the neural network and a momentum coefficient.
